(19) United States
(12) Patent Application Publication
(10) Pub. No.: US 2023/0294498 A1
(43) Pub. Date: Sep. 21, 2023

(54) VEHICLE COATING STRUCTURE

(71) Applicant: TOYOTA JIDOSHA KABUSHIKI KAISHA, Aichi-ken (JP)

(72) Inventors: Junya OGAWA, Okazaki-shi (JP); Nozomi TOYA, Toyota-shi (JP); Junya YAMAMOTO, Seto-shi (JP); Kenji YAMAGUCHI, Miyoshi-shi (JP)

(21) Appl. No.: 17/949,215

(22) Filed: Sep. 21, 2022

(30) Foreign Application Priority Data
Feb. 28, 2022 (JP) 2022-028987

(51) Int. Cl. B60J 11/00

(52) U.S. Cl. CPC B60J 11/00

(57) ABSTRACT

A vehicle coating structure formed on a surface of a base plate of an exterior member of a vehicle includes: a first coating layer formed on the surface of the base plate of the exterior member; a peelable layer formed on a surface of the first coating layer or the surface of the base plate, the peelable layer having peeling performance; and a second coating layer formed on a surface of the peelable layer and having thermal insulation performance.

### CROSS-REFERENCE TO RELATED APPLICATION

This application claims priority to Japanese Patent Application No. 2022-028987 filed on Feb. 28, 2022, incorporated herein by reference in its entirety.

### BACKGROUND

### 1. Technical Field

The present disclosure relates to a vehicle coating structure having a coating layer formed of a coating material having thermal insulation performance.

### 2. Description of Related Art

A vehicle used in a tropical area or in the summer might have such a case that the coating of the vehicle deteriorates due to sunlight. In order to solve such a problem, Japanese Unexamined Patent Application Publication No. 2016-036759 (JP 2016-036759 A) describes a vehicle coating structure including a coating layer formed of a coating material having thermal insulation performance.

### SUMMARY

In the vehicle having the coating structure including the coating layer having the thermal insulation performance, if the coating layer having the thermal insulation performance can be peeled off after the vehicle is used temporarily in a tropical area or in the summer, it is possible to restrain a decrease in the value of the vehicle at the time when the vehicle is used afterward.

In view of this, an object of the present disclosure is to provide a vehicle coating structure in which a coating layer having thermal insulation performance can be peeled off.

A vehicle coating structure according to the present disclosure is a vehicle coating structure formed on a surface of a base plate of an exterior member of a vehicle. The vehicle coating structure includes a first coating layer, a peelable layer, and a second coating layer. The first coating layer is formed on the surface of the base plate of the exterior member. The peelable layer is formed on a surface of the first coating layer or the surface of the base plate, the peelable layer having peeling performance. The second coating layer is formed on a surface of the peelable layer and having thermal insulation performance.

In the vehicle coating structure according to the present disclosure, the peelable layer and the second coating layer may be formed on the surface of the first coating layer of each of some exterior members from among a plurality of exterior members provided as the exterior member of the vehicle.

In the vehicle coating structure according to the present disclosure, the peelable layer and the second coating layer may be formed only on a visually observable surface of the first coating layer of the exterior member.

In the vehicle coating structure according to the present disclosure, the second coating layer may not contain a black coating material.

With the vehicle coating structure of the present disclosure, the coating layer having thermal insulation performance can be peeled off. Hereby, by peeling off the coating layer after the vehicle is used temporarily in a tropical area or in the summer, it is possible to restrain a decrease in the value of the vehicle when the vehicle is used afterward.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a vehicle according to an embodiment;

FIG. 2 is a sectional view illustrating a vehicle coating structure as an example of the embodiment;

FIG. 3 is a sectional view illustrating the vehicle coating structure in a part A in FIG. 1; and

FIG. 4 is another perspective view illustrating the vehicle according to the embodiment.

### DETAILED DESCRIPTION OF EMBODIMENTS

Hereinafter, an example of an embodiment of the present disclosure will be described in detail. In the following description, specific shapes, materials, directions, values, and the like are examples to facilitate understanding of the present disclosure and can be modified appropriately in conformity to a purpose, an object, a specification, and the like.

### Vehicle

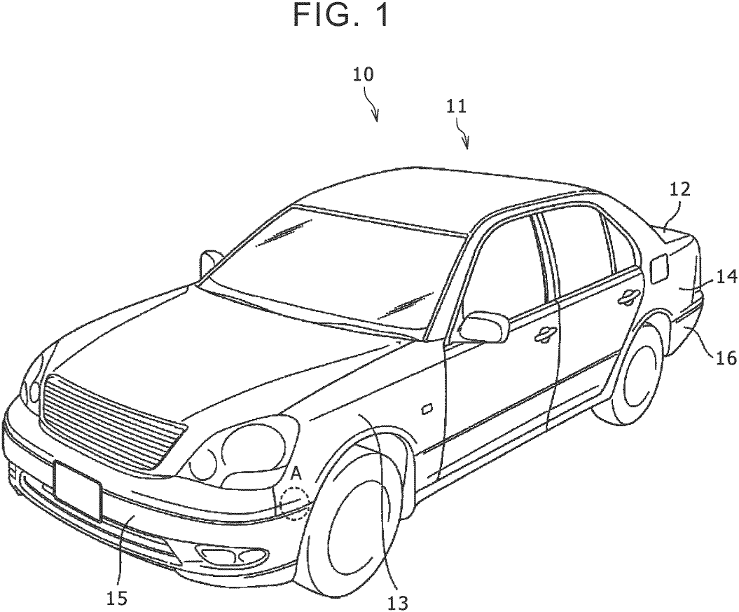

With reference to FIG. 1, the following describes a vehicle 10 according to the embodiment.

As illustrated in FIG. 1, the vehicle 10 is a four-wheeled passenger car, for example, but is not limited to this. The vehicle 10 includes exterior members 11. Here, the exterior members 11 include outer plates and exterior parts (described later).

The outer plates are members constituting a vehicle body and indicate visually observable outer plate panels (in other words, observable from outside the vehicle 10). The outer plates include, for example, a hood panel, a roof panel, a trunk lid 12, a front fender panel 13, a rear fender panel 14, a front door outer, a rear door outer, a front pillar, a center pillar, a rear pillar, and so on. As a material for the outer plates, a hot rolled steel plate or a cold rolled steel sheet is used, for example.

The exterior parts are visually observable outfitting components configured be assembled to the vehicle body. The exterior parts include, for example, a front bumper cover 15, a rear bumper cover 16, a rocker panel molding, a door handle, a fuel filler cover, a side mirror, a roof molding, a door belt molding, a weather strip, a window molding, and a shark fin, and so on. As a material for the exterior parts, a resin material is used. Note that a steel sheet may be used for the fuel filler cover.

### Coating Structure

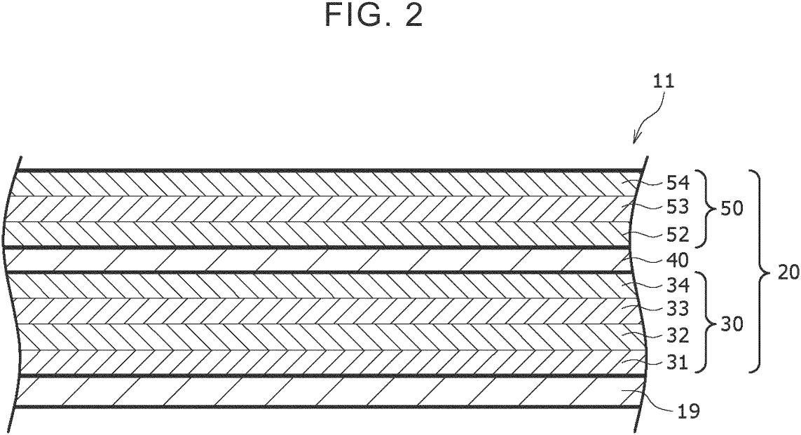

With reference to FIGS. 2 to 4, a coating structure 20 as an example of the embodiment will be described.

The outer plate as the exterior member 11 includes a base plate 19 made of a steel sheet or the like, and the coating structure 20 as a vehicle coating structure formed to cover the base plate 19. The exterior part as the exterior member 11 includes a base plate 19 made of a resin member, and the coating structure 20 as a vehicle coating structure formed to cover the resin member. That is, in a case where the exterior member 11 is the outer plate, the base plate 19 indicates a steel sheet having a surface on which the coating structure 20 is formed, and in a case where the exterior member 11 is the exterior part, the base plate 19 indicates a resin member having a surface on which the coating structure 20 is formed. Note that the base plate 19 includes molded-in color coating resin that is a material obtained by coloring resin itself such that a coloring material such as a pigment is mixed with a resin material or a bright material and a coloring material are mixed with a resin material.

The coating structure 20 includes a first coating layer 30 formed on the surface of the base plate 19, and a peelable layer 40 and a second coating layer 50 formed on a visually observable outer surface of the first coating layer 30 or the base plate 19. Note that the peelable layer 40 and the second coating layer 50 may be formed on the whole surface of the first coating layer 30. Note that, in a case where the base plate 19 is constituted by the aforementioned molded-in color coating resin, the peelable layer 40 and the second coating layer 50 may be formed on a visually observable outer surface of the base plate 19.

The first coating layer 30 is a layer formed on the surface of the base plate 19 as described above, and it is preferable that the first coating layer 30 be formed on each exterior member 11 before the vehicle 10 is completed. It is preferable that the first coating layer 30 be formed in a production factory for the vehicle 10.

The first coating layer 30 includes an electrodeposited layer 31 formed to cover the whole surface of the base plate 19, an intermediate coating layer 32 formed on the whole surface of the electrodeposited layer 31, a base layer 33 formed on the whole surface of the intermediate coating layer 32, and a clear layer 34 formed on the whole surface of the base layer 33.

The electrodeposited layer 31 is a layer formed by an electrodeposition coating film hardened by baking by electrodeposition coating. The electrodeposition coating may be cationic electrodeposition coating, for example. A cationic electrodeposition coating material is not limited particularly, and a well-known material is used. The cationic electrodeposition coating material may include cationic base resin, a hardening agent, and a pigment.

The intermediate coating layer 32 is a layer formed of a colored intermediate coating film by applying a colored intermediate coating material containing a titanium dioxide pigment and a color pigment. The titanium dioxide pigment and the color pigment are not limited particularly, and well-known pigments are used.

The base layer 33 is a layer formed of a base coating material coating film by applying a base coating material. The base coating material is not limited particularly, and a well-known material is used. As the base coating material, a solvent-based colored base coating material or an aqueous colored base coating material is preferably used.

The clear layer 34 is a layer where a clear coating film is formed by applying a clear coating material. Film-forming resin and a hardening agent to be used for the clear coating material are not limited particularly, and well-known materials are used. The clear coating material may contain the film-forming resin and the hardening agent.

In the meantime, the first coating layer 30 of the coating structure 20 of the exterior part includes a primer layer formed to cover the surface of the base plate 19, a base layer formed on the surface of the primer layer, and a clear layer formed on the surface of the base layer.

The peelable layer 40 is a resin coating film formed on the surface of the first coating layer 30. Since the peelable layer 40 is formed by applying an easily peelable coating material, the peelable layer 40 has a peeling property in comparison with the first coating layer 30 and the second coating layer 50. A material for the easily peelable coating material is not limited in particular, provided that the material is easily peelable from the first coating layer 30.

As the easily peelable coating material, a coating material formed by adding, to urethane-based resin or acrylic resin as a main material, for example, xylene, ethylbenzene, an oxidation inhibitor, methyl ethyl ketone, a silica reactant, titanium oxide (nanoparticles), an organic solvent, and so on is used preferably. The peelable layer 40 can be formed such that the coating material is applied by spray application, brush coating, or the like and then dried.

The peelable layer 40 and the second coating layer 50 may be formed on the surface of the first coating layer 30 of each of some exterior members 11 from among the exterior members 11 of the vehicle 10. More specifically, the peelable layer 40 and the second coating layer 50 may be formed only on the exterior member 11 to which sunlight is directly applied and which is visually outstanding.

For example, the peelable layer 40 and the second coating layer 50 may be formed only on the surface of the first coating layer 30 of each of the outer plates from among the exterior members 11. Further, the peelable layer 40 and the second coating layer 50 may be formed only on the surface of the first coating layer 30 of each of the hood panel and the roof panel from among the outer plates. Hereby, the coating materials necessary to form the peelable layer 40 and the second coating layer 50 are reduced, thereby making it possible to reduce material costs.

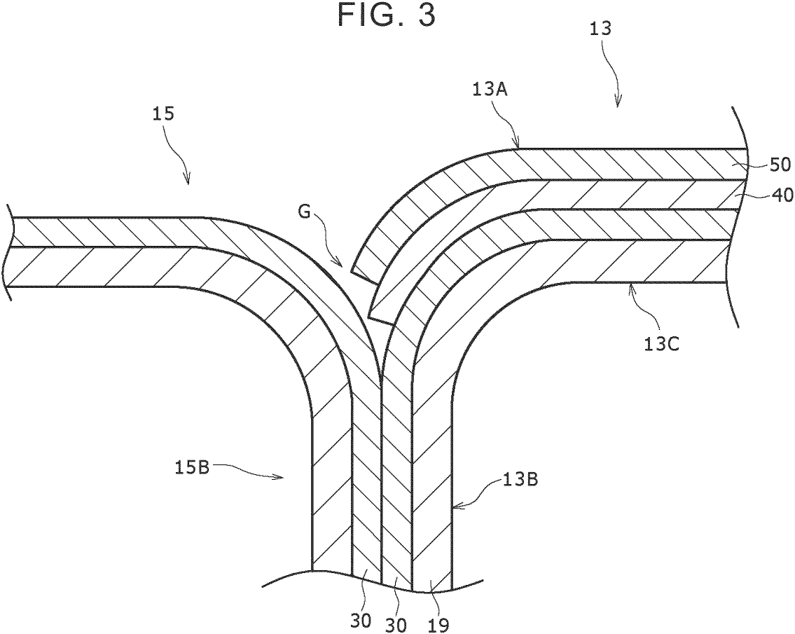

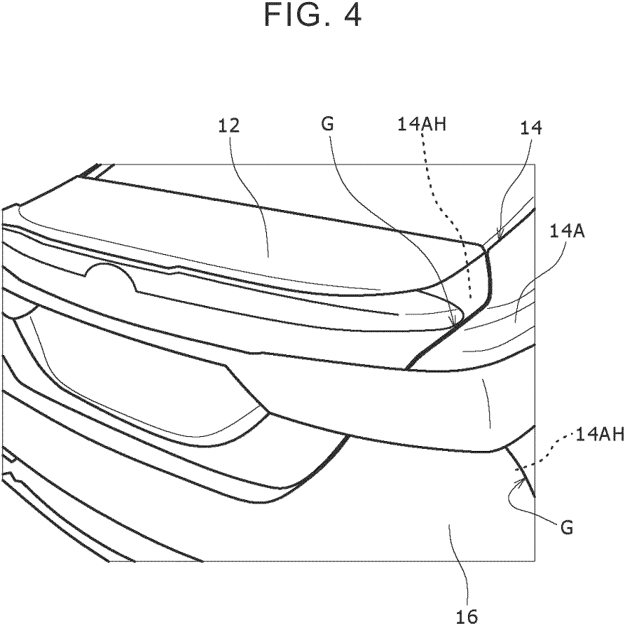

It is preferable that the peelable layer 40 and the second coating layer 50 be formed only on the visually observable surface of the first coating layer 30 of the exterior member 11. Here, the visually observable surface indicates a part other than a part covered with another member provided thereon in an overlapping manner such as a side end surface 13B (see FIG. 3) of the front fender panel 13 (details will be described later), and a part 14AH (see FIG. 4) of the rear fender panel 14 that is covered with the trunk lid 12 and the rear bumper cover 16.

Hereby, the peelable layer 40 and the second coating layer 50 can be applied to each exterior member 11 after the vehicle 10 is completed. Further, the peelable layer 40 and the second coating layer 50 can be peeled off without disassembling the exterior members 11. Hereby, the peelable layer 40 and the second coating layer 50 can be applied or peeled off in a repair shop provided along with a dealer for the vehicle 10. Note that the peelable layer 40 and the second coating layer 50 may be applied in a production factory for the vehicle 10.

The second coating layer 50 includes an intermediate coating layer 52 formed on the surface of the peelable layer 40, a base layer 53 formed on the surface of the intermediate coating layer 52, and a clear layer 54 formed on the surface of the base layer 53.

The intermediate coating layer 52 is a layer where a colored intermediate coating film is formed by applying a colored intermediate coating material having a thermal insulation property. A thermal-insulation coating material is not limited particularly, and a well-known material is used. As the colored intermediate coating material, a material having a light permeability of 0.1% or less in a wavelength region of 300 nm or more but 420 nm or less. Further, the colored intermediate coating material is a coating material which does not contain a black coating material configured to absorb sunlight and which has an L25-value adjusted to be equal to or more than 60 but less than 80 by a subtractive mixture of color pigments.

Since the intermediate coating layer 52 does not contain a black coating material configured to absorb sunlight, it is possible to prevent the intermediate coating layer 52 from increasing in temperature due to the heat of the sunlight and to improve the thermal insulation performance.

The intermediate coating layer 52 contains a titanium dioxide pigment and a color pigment. The color pigment may be two or more color pigments selected from a group including a blue-based pigment, a red-based pigment, a green-based pigment, and a yellow-based pigment that are color pigments having an infrared reflectance of 30% or more within a wavelength region from 780 nm to 2500 nm. The titanium dioxide pigment may have a first-order average particle diameter from 200 nm to 1000 nm.

With the intermediate coating layer 52, in a case where the vehicle is used in a tropical area or in the summer, it is possible to block sunlight. Hereby, with the coating structure 20, the first coating layer 30 can be protected from the sunlight by the second coating layer 50.

The base layer 53 is a layer formed of a base coating material coating film by applying a base coating material. The base coating material is not limited particularly, and a well-known material is used. As the base coating material, a solvent-based colored base coating material or an aqueous colored base coating material is preferably used.

The clear layer 54 is a layer where a clear coating film is formed by applying a clear coating material. Film-forming resin and a hardening agent to be used for the clear coating material are not limited particularly, and well-known materials are used. The clear coating material may contain the film-forming resin, the hardening agent, and so on.

As described above, the peelable layer 40 and the second coating layer 50 are formed only on the visually observable surface of the first coating layer 30. For example, as illustrated in FIG. 3, the visually observable surface of the front fender panel 13 is an outer surface 13A of the front fender panel 13 and does not include the side end surface 13B and a back surface 13C.

The side end surface 13B of the front fender panel 13 is the surface of a part bent toward the inside of the vehicle 10 from the outer surface 13A. The side end surface 13B faces a side end surface 15B of the front bumper cover 15 via a gap. The back surface 13C of the front fender panel 13 is a surface on the opposite side from the outer surface 13A.

In other words, outer peripheral edges G of the peelable layer 40 and the second coating layer 50 of the front fender panel 13 are formed along a joined portion between the front fender panel 13 and the front bumper cover 15. Hereby, it is possible to peel the peelable layer 40 and the second coating layer 50 of the front fender panel 13 without removing the front bumper cover 15 from the front fender panel 13.

Further, for example, as illustrated in FIG. 4, the visually observable surface of the rear fender panel 14 is a part of the outer surface 14A except the part 14AH covered by the trunk lid 12 and the rear bumper cover 16 provided to overlap with the part 14AH.

In other words, the outer peripheral edges G of the peelable layer 40 and the second coating layer 50 of the rear fender panel 14 are formed along outer peripheral edges of the trunk lid 12 and the rear bumper cover 16 on the outer surface 14A of the rear fender panel 14. Hereby, the peelable layer 40 and the second coating layer 50 of the rear fender panel 14 can be peeled off in a state where the trunk lid 12 and the rear bumper cover 16 are closed relative to the rear fender panel 14.

### Effects

With the vehicle 10 having the coating structure 20, when the peelable layer 40 and the second coating layer 50 having the thermal insulation performance are peeled off after the vehicle 10 is used temporarily in a tropical area or in the summer, it is possible to restrain a decrease in the value of the vehicle 10 as a used car when the vehicle 10 is used afterward.

Further, in the vehicle 10 having the coating structure 20, the peelable layer 40 and the second coating layer 50 are formed only on the visually observable surface of the first coating layer 30 of the exterior member 11. Accordingly, it is possible to apply or peel off the peelable layer 40 and the second coating layer 50 to or from each exterior member 11 in a repair shop provided along with a dealer, for example, after the vehicle 10 is completed. Further, for example, a user of the vehicle 10 can peel off the peelable layer 40 and the second coating layer 50.

Note that it is needless to say that the present disclosure is not limited to the above embodiment and its modifications, and various changes and alterations can be made within what is described in Claims.

What is claimed is:

1. A vehicle coating structure formed on a surface of a base plate of an exterior member of a vehicle, the vehicle coating structure comprising:
a first coating layer formed on the surface of the base plate of the exterior member;
a peelable layer formed on a surface of the first coating layer or the surface of the base plate, the peelable layer having peeling performance; and
a second coating layer formed on a surface of the peelable layer and having thermal insulation performance.

2. The vehicle coating structure according to claim 1, wherein the peelable layer and the second coating layer are formed on the surface of the first coating layer of each of some exterior members from among a plurality of exterior members provided as the exterior member of the vehicle.

3. The vehicle coating structure according to claim 1, wherein the peelable layer and the second coating layer are formed only on a visually observable surface of the first coating layer of the exterior member.

4. The vehicle coating structure according to claim 1, wherein the second coating layer does not contain a black coating material.
